(19) United States
(12) Patent Application Publication
(10) Pub. No.: US 2024/0069721 A1
(43) Pub. Date: Feb. 29, 2024

(54) MEMORY WITH SWITCHABLE CHANNELS

(71) Applicant: Micron Technology, Inc., Boise, ID (US)

(72) Inventors: Sundararajan Sankaranarayanan, Fremont, CA (US); Chulbum Kim, San Jose, CA (US); Xiangyu Tang, San Jose, CA (US)

(21) Appl. No.: 17/823,909

(22) Filed: Aug. 31, 2022

(51) Int. Cl. G06F 3/06

(52) U.S. Cl. CPC G06F 3/0604; G06F 3/0635; G06F 3/0659; G06F 3/0679

(57) ABSTRACT

Memory with switchable channels is disclosed herein. In one embodiment, a system comprises a controller, a plurality of memory dies, and a switch matrix. The switch matrix is coupled to the controller via two or more controller-side channels, and to the plurality of memory dies via a set of memory-side channels. The switch matrix is configured to selectively couple each controller-side channel of the two or more controller-side channels to each memory-side channel of the set of memory-side channels to provide dynamically configurable connections between the controller and one or more memory dies of the plurality of memory dies.

### TECHNICAL FIELD

The present disclosure is related to memory systems, devices, and associated methods. For example, several embodiments of the present disclosure are directed to memory devices with switchable channels.

### BACKGROUND

Memory devices are widely used to store information related to various electronic devices such as computers, wireless communication devices, cameras, digital displays, and the like. Memory devices are frequently provided as internal, integrated circuits and/or as part of external removable devices in computers or other electronic devices. There are many different types of memory, including volatile and non-volatile memory. Volatile memory, including static random-access memory (SRAM), dynamic random-access memory (DRAM), and synchronous dynamic random-access memory (SDRAM), among others, may require a source of applied power to maintain its data. Non-volatile memory, by contrast, can retain its stored data even when not externally powered. Non-volatile memory is available in a wide variety of technologies, including flash memory (e.g., NAND and NOR), phase change memory (PCM), ferroelectric random-access memory (FeRAM), resistive random-access memory (RRAM), and magnetic random-access memory (MRAM), among others. Improving memory devices, generally, may include increasing memory cell density, increasing performance (e.g., read, write, erase speeds) or otherwise reducing operational latency, increasing reliability, increasing data retention, reducing power consumption, reducing manufacturing costs, or reducing dimensional attributes, among other metrics.

### BRIEF DESCRIPTION OF THE DRAWINGS

The disclosure will be understood more fully from the detailed description given below and from the accompanying drawings of various embodiments of the present disclosure. The components in the drawings are not necessarily to scale. Instead, emphasis is placed on illustrating clearly the principles of the present technology. The drawings should not be taken to limit the disclosure to the specific embodiments, but are for explanation and understanding only.

FIG. 1 is a partially schematic block diagram of a memory system.

FIG. 2 is a partially schematic block diagram of a memory system configured in accordance with various embodiments of the present technology.

FIG. 3 is a partially schematic block diagram of another memory system configured in accordance with various embodiments of the present technology.

FIGS. 4-9 are partially schematic block diagrams of memory devices having one or more switch matrices, the memory devices and switch matrices configured in accordance with various embodiments of the present technology.

FIG. 10 is a partially schematic block diagram of a system that includes a memory device configured in accordance with various embodiments of the present technology.

### DETAILED DESCRIPTION

As discussed in greater detail below, the technology disclosed herein relates to memory systems having switch matrices operably coupling memory controllers to memory devices. More specifically, the present technology is directed to switch matrices that are each configured to selectively couple (e.g., via switches) each of two or more front-end (e.g., controller-side, first) communication channels to a same set of back-end (e.g., memory-side, NAND-side, die-side, package-side, second) communication channels. As such, each of the front-end communication channels coupled to a switch matrix of the present technology can, via the switch matrix, be used to transmit communications to or receive communications from any of the back-end communication channels in the set. In other words, switch matrices of the present technology enable the front-end communication channels to be shared across a plurality of memory devices (e.g., memory packages, memory dies) coupled to different back-end communication channels.

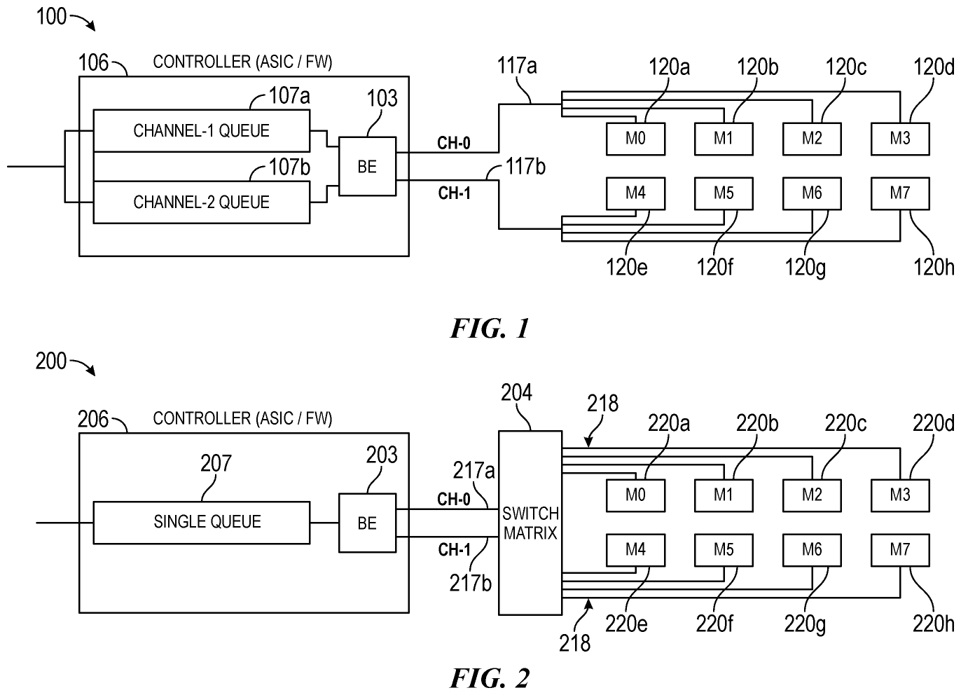

In the illustrated embodiments below, the memory devices are primarily described in the context of devices incorporating NAND-based storage media (e.g., NAND flash). Memory devices configured in accordance with other embodiments of the present technology, however, can include other types of memory devices (e.g., hard disk drives, phase change memory, ferroelectric, etc.) and/or can include main memories that are not NAND-based (e.g., that are NOR-based) or only partially NAND-based. Moreover, memory devices configured in accordance with still other embodiments of the present technology can include volatile memories, such as DRAM and/or SRAM memories. A person skilled in the art will understand that the technology may have additional embodiments and that the technology may be practiced without several of the details of the embodiments described below with reference to FIGS. 1-10.

### A. OVERVIEW

Many memory systems include multiple channels for handling communications (e.g., of commands, data, and/or other information) between a memory controller and a plurality of memory devices. For example, FIG. 1 is a partially schematic block diagram of a memory system 100 including a memory controller 106 and a plurality of memory devices 120 (identified individually as memory devices 120a-120h in FIG. 1). The memory controller 106 is operably coupled to each of the plurality of memory devices 120a-120b via corresponding ones of a plurality of channels 117. More specifically, a first channel 117a operably couples a first channel queue 107a of the memory controller 106 and back-end circuitry 103 (e.g., back-end drivers) of the memory controller 106 to the memory devices 120a-120d, and a second channel 117b operably couples a second channel queue 107b of the memory controller 106 and the back-end circuitry 103 to the memory devices 120e-120h. The first channel queue 107a is dedicated for use with the first channel 117a, and the second channel queue 107b is dedicated for use with the second channel 117b.

The channel queues 107 are used to queue commands or other communications for the back-end circuitry 103 to drive to corresponding ones of the memory devices 120a-120h. For example, a command intended for all or a subset of the memory devices 120a-120d can be queued in the first channel queue 107a until (a) the command reaches the front of the queue, (b) the first channel 117a is available (e.g., is unoccupied or free) to transmit the command to the memory devices 120a-120d, and/or (c) the memory devices 120a-120d are available to receive and/or execute the command. In other words, each of the channel queues 107 are used to queue controller-to-device communications upon the occurrence of a channel collision (e.g., a scenario in which a same channel is used to transmit or receive a sequence of two or more communications but transmission of a communication in the sequence is delayed until the channel has completed transmitting a communication appearing earlier in the sequence) on the corresponding channel 117 or upon the occurrence of a memory device collision (e.g., a scenario in which a sequence of two or more communications involve a same memory device but transmission of (or execution of a command within) a communication in the sequence is delayed until the memory device completes transmitting or receiving (or executing a command within) a communication appearing earlier in the sequence).

Occasionally, channel and/or device collisions can occur that involve one of the channels 117 but not the other such that transmission of communications to or from one or more of the memory devices 120a-120h can be delayed despite the availability of channel resources. For example, as the first channel 117a is utilized to transmit communications to or from the memory device 120a of FIG. 1, the second channel 117b may be available (e.g., not currently being used to transmit or receive communications to the memory devices 120e-120h). Furthermore, the memory devices 120b-120d may be available to send or receive communications but are unable to do so because communications transmitted to or from the memory device 120a are currently occupying the first channel 117a. This constitutes a waste of available channel resources, most notably the availability of the second channel 117b in the above example. As shown in FIG. 1, however, the second channel 117b operably connects the memory controller 106 to only the memory devices 120e-120h. Stated another way, the second channel 117b cannot be used to transmit communications to or receive communications from any of the memory devices 120b-120d in the configuration illustrated in FIG. 1. In other words, the configuration illustrated in FIG. 1 does not optimize performance, quality-of-service (QOS), and command latency profiles (especially under mixed read and write workloads) of the memory system 100, any one or more of which can be important factors for certain memory systems (e.g., enterprise solid-state drive (SSD) systems).

To address these concerns, the present technology is directed to memory systems having switch matrices that can selectively couple two or more front-end (e.g., controller-side or first) channels to a same set of memory devices. This can provide dynamically configurable connections between a memory controller and one or more memory devices of the set. For example, FIG. 2 is a partially schematic block diagram of a memory system 200 configured in accordance with various embodiments of the present technology. As shown, the memory system 200 includes a memory controller 206 operably coupled to a plurality of memory devices 220a-220h via a switch matrix 204. More specifically, the switch matrix selectively couples a plurality of front-end channels 217 (identified individually in FIG. 2 as first front-end channel 217a and second front-end channel 217b) to a plurality of back-end (e.g., memory-side or second) channels 218. Stated another way, the switch matrix 204 is configured (a) to selectively couple the first front-end channel 217a to any one or more of the back-end channels 218 such that the memory system 200 can use the first front-end channel 217a to send communications to or receive communications from any one or more of the memory devices 220a-220h, and/or (b) to selectively couple the second front-end channel 217b to any one or more of the back-end channels 218 such that the memory system 200 can use the second front-end channel 217b to send communications to or receive communications from any one or more of the memory devices 220a-220h.

In some embodiments, the memory controller 206 can include a single command queue 207 that is shared between the front-end channels 217 (as opposed to multiple command queues that are each dedicated to only one front-end channel, as is shown in FIG. 1). The command queue 207 can be configured, upon the occurrence of channel and/or device collisions, to queue commands or other communications for back-end circuitry 203 of the memory controller 206 to drive to corresponding ones of the memory devices 220a-220h via either of the front-end channels 217. Using a single command queue 207 that is shared amongst the front-end channels 217 can facilitate transmitting a communication in the queue more quickly (in comparison to using multiple command queues that are each dedicated to only one front-end channel) because a communication in the single command queue 207 can be transmitted to one or more of the memory devices 220a-220h as soon as any of the front-end channels 217 and the corresponding memory devices 220a-220h are available.

In this manner, the present technology uses at least one switch matrix to share two or more front-end communications channels across a plurality of memory devices so as to expand access to available channel resources. Thus, the present technology is expected to enable better utilization of available channel resources. In turn, the present technology is expected to increase performance and quality-of-service (QoS) of corresponding memory systems. The present technology is also expected to improve command latency profiles of such memory systems (e.g., under mixed read and write workloads).

### B. SELECTED EMBODIMENTS OF MEMORY SYSTEMS AND DEVICES WITH SWITCHABLE CHANNELS, AND ASSOCIATED METHODS

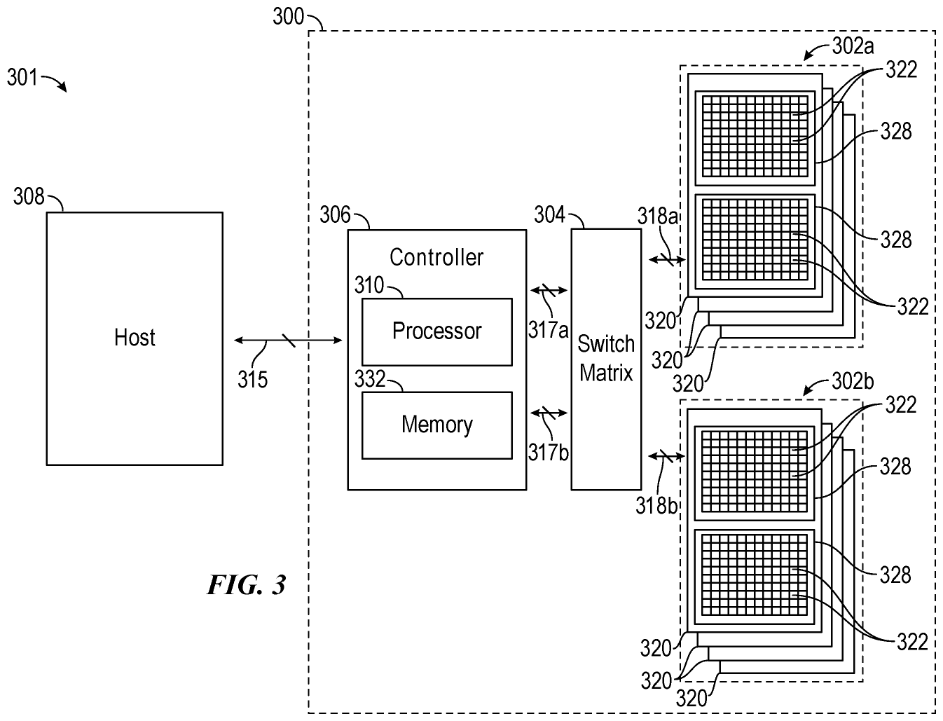

FIG. 3 is a block diagram of a memory system 301 having a memory device 300 configured in accordance with several embodiments of the present technology. An example of a memory device 300 is a storage system, such as a solid-state drive (SSD). In some embodiments, the memory device 300 is a hybrid memory/storage sub-system.

As shown, the memory device 300 includes a plurality of memory packages 302 (identified individually in FIG. 3 as first memory package 302a and second memory package 302b), a controller 306 (e.g., a processing device), and a switch matrix 304 operably coupling the plurality of memory packages 302 to the controller 306. The controller 306 operably couples the plurality of memory packages 302 to a host device 308, such as an upstream central processor (CPU). Although shown with two memory packages 302 in FIG. 3, the memory device 300 can include a greater or lesser number of memory packages 302 (e.g., one, four, eight, nine, sixteen, or more memory packages 302) in other embodiments of the present technology.

Each of the memory packages 302 includes a plurality of memory regions, or memory units 320, that each include a plurality of memory cells 322. Memory units 320 can be individual memory dies, memory planes in a single memory die, a stack of memory dies vertically connected with through-silicon vias (TSVs), or the like. In some embodiments, one or more of the memory units 320 can be co-located on a single die and/or distributed across multiple packages 302. For the sake of clarity and example, in the discussion that follows, memory units 320 are referred to as memory dies 320 arranged in respective memory packages 302.

The memory cells 322 can include, for example, NAND flash and/or other suitable storage elements (e.g., NOR flash, read only memory (ROM), electrically erasable programmable ROM EEPROM, erasable programmable ROM (EPROM), ferroelectric, magnetoresistive, phase change memory, etc.) configured to store data persistently or semi-persistently. In one example, the memory cells 322 are arranged in memory pages that are arranged in memory blocks 328. Continuing with this example, the memory blocks 328 can be arranged in memory planes, and the memory planes can be arranged in respective memory dies 320. As a specific example, the memory cells 322 can include NAND flash storage elements arranged in a 3D NAND topology, configuration, or architecture. Memory packages 302 and/or individual memory dies 320 can also include other circuit components or memory subsystems (not shown), such as multiplexers, decoders, buffers, read/write drivers, address registers, data out/data in registers, etc., for accessing and/or programming (e.g., writing) the memory cells 322 and other functionality, such as for processing information and/or communicating with the controller 306 via the switch matrix 304.

The controller 306 can be a microcontroller, special purpose logic circuitry (e.g., a field programmable gate array (FPGA), an application specific integrated circuit (ASIC), firmware, etc.), or another suitable processor. The controller 306 can include a processor 310 configured to execute instructions stored in memory. The processor 310 can be a processing device. In operation, the controller 306 can directly read, write, or otherwise program (e.g., erase) regions of memory in the memory dies 320 and memory packages 302, such as by reading from and/or writing to groups of memory cells 322 (e.g., memory pages, stripes of memory pages, memory blocks 328, etc.).

In the illustrated example, the controller 306 includes an embedded memory 332 configured to store various processes, logic flows, and routines for controlling operation of the memory device 300, including managing the memory packages 302 and handling communications between the memory device 300 and the host device 308. In some embodiments, the embedded memory 332 can include memory registers storing, for example, memory pointers, fetched data, etc. The embedded memory 332 can also include read-only memory (ROM) for storing micro-code.

The controller 306 communicates with the host device 308 over a system bus 315. In some embodiments, the host device 308 and the controller 306 can communicate over a serial interface, such as a serial attached SCSI (SAS), a serial AT attachment (SATA) interface, a peripheral component interconnect express (PCIe), or other suitable interface (e.g., a parallel interface). The host device 308 can send various requests (in the form of, e.g., a packet or stream of packets) to the controller 306. A request can include a command to write, erase, read or return information, and/or to perform a particular operation (e.g., a TRIM operation). In some embodiments, the host device 308 can send various vendor specific (VS) commands to perform one or more restricted operations (e.g., access a restricted region of the memory packages 302, enter a debugging mode, reset restricted data, etc.).

As shown, the controller 306 communicates with the memory packages 302 via the switch matrix 304. More specifically, a plurality of front-end channels 317 (identified individually as first front-end channel 317a and second front-end channel 317b in FIG. 3, and also referred to herein as first channels) operably couple the controller 306 to a front-end interface of the switch matrix 304, and a plurality of back-end channels 318 (identified individually as first back-end channel 318a and second back-end channel 318b in FIG. 3, and also referred to herein as second channels) operably couple a back-end interface of the switch matrix 304 to corresponding memory packages 302. In some embodiments, a back-end channel 318 operably couples the switch matrix 304 to individual memory dies 320 within a corresponding memory package 302. In these and other embodiments, a back-end channel 318 operably couples the switch matrix 304 to a corresponding memory package 302, and circuitry (e.g., an input/output expander) internal the memory package 302 routes communications from/to the back-end channel 318 to/from individual memory dies 320 of the memory package 302.

In some embodiments, the controller 306, the switch matrix 304, and/or the plurality of memory packages 302 communicate with one another in accordance with Open NAND Flash Interface (ONFI) protocols. Thus, the front-end channels 317 and/or the back-end channels 318 can be ONFI channels, and the controller 306 and/or the memory packages 302 may include ONFI communication interfaces. In other embodiments, the controller 306, the switch matrix 304, and/or the plurality of memory packages 302 can communicate in accordance with other communication protocols.

As shown in FIG. 3, the switch matrix 304 is positioned between the controller 306 and the plurality of memory packages 302, such as on a printed circuit board (PCB) or other substrate (not shown) on which the controller 306 and/or the memory packages 302 may also be positioned. In other embodiments, the switch matrix 304 can be incorporated into the controller 306. In still other embodiments, the switch matrix 304 can be incorporated into one or more of the memory packages 302. For example, all or a subset of the switch matrix 304 (a) can be incorporated into a memory package 302 (e.g., into or onto a package substrate of the memory package 302), and/or (b) can be integrated into circuitry (e.g., into an input/output expander) internal the memory package 302 or can be a standalone component within the memory package 302. Although shown with a single switch matrix 304 in FIG. 3, the memory device 300 can include more than one switch matrix in other embodiments (e.g., in embodiments including more than two front-end channels 317).

In operation, the switch matrix 304 is configured to selectively couple one or more of the front-end channels 317 to one or more of the back-end channels 318 to facilitate transmitting communications between the controller 306 and one or more of the memory packages 302. For example, the switch matrix 304 can selectively couple (e.g., via a first set of switches internal the switch matrix 304) the first front-end channel 317a to (a) the first back-end channel 318a, (b) the second back-end channel 318b, or (c) both of the back-end channels 318. Thus, communications can be transmitted or received over the first front-end channel 317a to facilitate communication between (a) the controller 306 and (b) any one or more of the memory dies 320 and/or any one or more of the memory packages 302 of the memory device 300. Continuing with the above example, the switch matrix 304 can additionally, or alternatively, selectively couple (e.g., via a second set of switches internal the switch matrix 304) the second front-end channel 317b to (a) the first back-end channel 318a, (b) the second back-end channel 318b, or (c) both of the back-end channels 318. Thus, communications can be transmitted or received over the second front-end channel 317b to facilitate communication between (a) the controller 306 and (b) any one or more of the memory dies 320 and/or any one or more of the memory packages 302 of the memory device 300. In other words, the switch matrix 304 enables both of the front-end channels 317 to be shared across the memory packages 302 such that either or both of the front-end channels 317 can be used to transmit communications between (a) the controller 306 and (b) any of the memory packages 302 and/or any one or more of the memory dies 320 within the memory packages 302.

In some embodiments, the switch matrix 304 can be controlled by the controller 306. For example, when the controller 306 operates to transmit a communication to the first memory package 302a, the controller 306 (a) can select which of the front-end channels 317 to use to transmit the communication to the switch matrix 304 (e.g., depending on availability of the first front-end channel 317a and/or the second front-end channel 317b) and (b) can instruct the switch matrix 304 to couple the selected front-end channel 317 to the first back-end channel 318a. In response to the instructions received from the controller 306, the switch matrix 304 can couple the selected front-end channel 317 to the first back-end channel 318a. As another example, when the second memory package 302b operates to transmit a communication to the controller 306 over the second back-end channel 318b, the controller 306 (a) can select which of the front-end channels 317 to use to receive the communication (e.g., depending on availability of the first front-end channel 317a and/or the second front-end channel 317b) and (b) can instruct the switch matrix 304 to couple the selected front-end channel 317 to the second back-end channel 318b. In response to the instructions received from the controller 306, the switch matrix 304 can couple the selected front-end channel 317 to the second back-end channel 318b.

In these and other embodiments, the switch matrix 304 can manage connections between the front-end channels 317 and the back-end channels 318. For example, the switch matrix 304 can receive a communication from the controller 306 via either the first front-end channel 317a or the second front-end channel 317b. The communication can include an indication that the communication is intended for the first memory package 302a. In response, the switch matrix 304 can (a) couple the first front-end channel 317a or the second front-end channel 317b to the first back-end channel 318a (e.g., depending on availability of the first front-end channel 317a and/or the second front-end channel 317b) and/or (b) route (e.g., forward, relay, pass, feed, transmit, redrive) the communication to the first memory package 302a via the first back-end channel 318a. Alternatively, the controller 306 can signal the switch matrix 304 that it would like to send a communication to the first memory package 302a. In response to the signal, the switch matrix 304 can couple (a) the first front-end channel 317a and/or the second front-end channel 317b (e.g., depending on availability of the first front-end channel 317a and/or the second front-end channel 317b) to (b) the first back-end channel 318a and/or the second front-end channel 317b. The controller 306 can then transmit the communication to the switch matrix 304 via the coupled one of the front-end channels 317, and the switch matrix 304 can route (e.g., forward, relay, pass, feed, transmit, redrive) the communication to the first memory package 302a.

As another example, the switch matrix 304 can receive a communication from the second memory package 302b via the second back-end channel 318b. The communication may include an indication that the communication is intended for the controller 306. In response to receiving the communication and/or to the indication, the switch matrix 304 can (a) couple the second back-end 318b to the first front-end channel 317a or the second front-end channel 317b (e.g., depending on the availability of the first front-end channel 317a and/or the second front-end channel 317b) and/or (b) route (e.g., forward, relay, pass, feed, transmit, redrive) the communication to the controller 106 via the coupled one of the front-end channels 317. Alternatively, the second memory package 302b can signal the switch matrix 304 that it would like to send a communication to the controller 306. In response to the signal, the switch matrix 304 can couple (a) the second back-end channel 318b to (b) the first front-end channel 317a and/or the second front-end channel 317b (e.g., depending on the availability of the first front-end channel 317a and/or the second front-end channel 317b). The second memory package 302b can then transmit the communication to the switch matrix 304 via the second back-end channel 318b, and the switch matrix 304 can route (e.g., forward, relay, pass, feed, transmit, redrive) the communication to the controller 306 via the coupled one of the front-end channels 317.

Additionally, or alternatively, the switch matrix 304 can be controlled by one or more of the memory packages 302 and/or by one or more of the memory dies 320 within the memory packages 302. For example, when the second memory package 302b operates to transmit a communication to the controller 306 over the second back-end channel 318b, the second memory package 302b (a) can select which of the front-end channels 317 to use to transmit the communication from the switch matrix 304 to the controller 306 (e.g., depending on availability of the first front-end channel 317a and/or the second front-end channel 317b) and/or (b) can instruct the switch matrix 304 to couple one of the front-end channels 317 to the second back-end channel 318b. In response to the instructions received from the second memory package 302b, the switch matrix 304 can couple the selected and/or the one of the front-end channels 317 to the second back-end channel 318b. As another example, when the controller 306 operates to transmit a communication to the first memory package 302a over one or more of the front-end channels 317 (e.g., depending on availability of the first front-end channel 317a and/or the second front-end channel 317b), the first memory package 302a can instruct the switch matrix 304 to couple the first back-end channel 318a to the one or more of the front-end channels 317. In response to the instructions received from the first memory package 302a, the switch matrix 304 can couple the first back-end channel 318a to the one or more of the front-end channels 317.

Although discussed in detail above as being configured to selectively couple one or more front-end channels 317 to one or more back-end channels 318, the switch matrix 304 can be configured to selectively couple two or more back-end channels 318 to one another in some embodiments of the present technology. For example, the switch matrix 304 can selectively couple the first back-end channel 318a to the second back-end channel 318b to facilitate communications between (a) the first memory package 302a and/or one or more memory dies 320 within the first memory package 302a, and (b) the second memory package 302b and/or one or more memory dies 320 within the second memory package 302b.

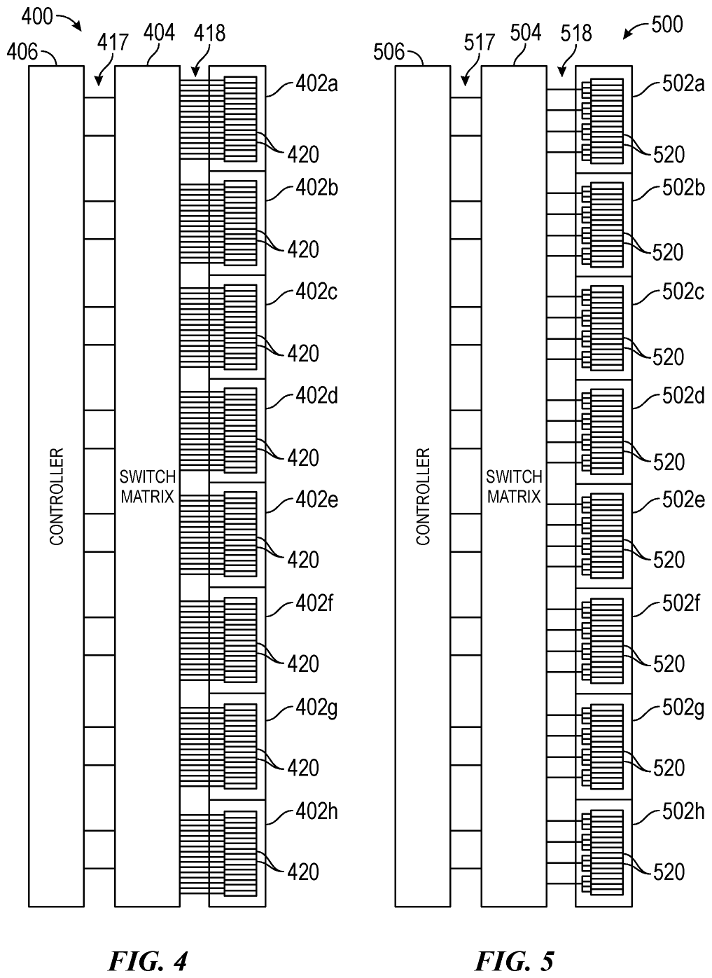

FIGS. 4-9 are partially schematic block diagrams of memory devices 400-900, respectively, configured in accordance with various embodiments of the present technology. FIGS. 4-9 are discussed in detail below for the sake of clarity and example, and to expand upon several aspects of the present technology discussed above. Aspects from any of the memory devices 200-900 can be combined to form further embodiments of the present technology. For example, a memory device configured in accordance with various embodiments of the present technology can employ an assortment of the switch matrices illustrated in two or more of FIGS. 2-9.

Referring first to FIG. 4, the memory device 400 includes a controller 406, a plurality of memory packages 402 (identified individually in FIG. 4 as memory packages 402a-402h), and a switch matrix 404 operably coupling the controller 406 to the plurality of memory packages 402 via a plurality of front-end channels 417 and a plurality of back-end channels 418. The controller 406 can be generally similar to the controller 206 and/or the controller 306 of FIGS. 2 and/or 3 discussed above. Additionally, or alternatively, the memory packages 402 can be generally similar to the memory devices 220 of FIG. 2 and/or the memory packages 302 of FIG. 3 discussed above.

As shown, the switch matrix 404 is positioned between the controller 406 and the plurality of memory packages 402, such as on a PCB or other substrate on which the controller 406 and/or the plurality of memory packages 402 may also be positioned. Sixteen front-end channels 417 operably couple the controller 406 to the switch matrix 404. In addition, one-hundred and twenty-eight (128) back-end channels 418 operably couple the switch matrix 404 to the plurality of memory packages 402. Thus, the switch matrix 404 can be referred to as a 16:128 switch matrix.

The memory device 400 includes eight memory packages 402, and each of the memory packages 402 includes sixteen memory dies 420. The memory device 400 therefore includes one-hundred and twenty-eight (128) memory dies 420. In addition, each memory die 420 of a memory package 402 can be operably coupled to (a) an external pin or terminal of the memory package 402 and/or (b) a corresponding one of the back-end channels 418. Thus, sixteen back-end channels 418 can be used to operably couple one of the memory packages 402 to the switch matrix 404.

In operation, the switch matrix 404 can be configured to selectively couple any one or more of the front-end channels 417 to any one or more of the back-end channels 418. Because each memory die 420 is operably coupled to a dedicated back-end channel 418 in the illustrated embodiment, the switch matrix 404 can facilitate the controller 406 communicating directly with individual memory dies 420 of a memory package 402. Additionally, or alternatively, the switch matrix 404 may be configured to selectively couple two or more of the back-end channels 418 to one another. This can facilitate transmitting communications between two or more individual memory dies 420 of one or more of the memory packages 402.

Although shown with sixteen front-end channels 417, one-hundred and twenty-eight (128) back-end channels 418, eight memory packages 402, and sixteen memory dies 420 per memory package 402, the memory device 400 can, in other embodiments, include (a) more than sixteen or less than sixteen front-end channels 417; (b) more than one-hundred and twenty-eight (128) or less than one-hundred and twenty-eight (128) back-end channels 418; (c) more than eight or less than eight memory packages 402; and/or (d) more than sixteen or less than sixteen memory dies 420 per memory package 402. Additionally, or alternatively, the memory device 400 can include a greater or lesser number of external pins (e.g., more than sixteen or less than sixteen external pins) per memory package 402. In some embodiments, the number of memory dies 420, external pins, and/or back-end channels 418 coupled to a memory package 402, can vary across memory packages 402 of the memory device 400. Furthermore, although shown with a single switch matrix 404 in FIG. 4, the memory device 400 may include more than one switch matrix 404 in other embodiments. Moreover, all or a subset of the switch matrix 404 can be incorporated into the controller 406 and/or into one or more of the memory packages 402 in some embodiments.

Referring to FIG. 5, the memory device 500 is similar to the memory device 400 of FIG. 4 in that the memory device 500 includes a controller 506, a plurality of memory packages 502 (identified individually in FIG. 5 as memory packages 502a-502h), and a switch matrix 504 operably coupling the controller 506 to the plurality of memory packages 502 via a plurality of front-end channels 517 and a plurality of back-end channels 518. In addition, the switch matrix 504 is positioned between the controller 506 and the plurality of memory packages 502, such as on a PCB or other substrate on which the controller 506 and/or the plurality of memory packages 502 may also be positioned. Sixteen front-end channels 517 operably couple the controller 506 to the switch matrix 504, but thirty-two (32) back-end channels 518 (as opposed to one-hundred and twenty-eight (128) back-end channels 418, as is used in FIG. 4) operably couple the switch matrix 504 to the plurality of memory packages 502. Thus, the switch matrix 504 can be referred to as a 16:32 switch matrix.

The memory device 500 includes eight memory packages 502, and each of the memory packages 502 includes sixteen memory dies 520. The memory device 500 therefore includes one-hundred and twenty-eight (128) memory dies 520. The memory dies 520 of a memory package 502 are organized into groups of four. Each group can be operably coupled to (a) an external pin or terminal of the memory package 502 and/or (b) a corresponding one of the back-end channels 518. Thus, four back-end channels 518 can be used to operably couple one of the memory packages 502 to the switch matrix 504.

In operation, the switch matrix 504 can be configured to selectively couple any one or more of the front-end channels 517 to any one or more of the back-end channels 518, and/or to selectively couple any two or more of the back-end channels 518 to one another. Because each back-end channel 518 is operably coupled to a group of four memory dies 520 in the illustrated embodiment, the switch matrix 504 can facilitate the controller 506 communicating directly with the individual groups of memory dies 520 of a memory package 502. In other words, in comparison with the switch matrix 404 of the memory device 400 of FIG. 4, the switch matrix 504 provides less flexibility with respect to communicating with individual memory dies 520 of a memory package 502. In addition, in some embodiments, only one of the memory dies 520 per group can use the corresponding back-end channel 518 at a time to transmit communications. Thus, it is expected that a higher number of channel collisions per back-end channel 518 and/or front-end channel 517 may occur within the memory device 500 than within the memory device 400. That said, the memory device 500 can offer a reduction in routing complexity (e.g., less switching circuitry internal the switch matrix 504, less back-end channels 518, and/or less external pins per memory package 502) in comparison to the memory device 400.

Although shown with sixteen front-end channels 517, thirty-two (32) back-end channels 518, eight memory packages 502, and sixteen memory dies 520 per memory package 502, the memory device 500 can, in other embodiments, include (a) more than sixteen or less than sixteen front-end channels 517; (b) more than thirty-two (32) or less than thirty-two (32) back-end channels 518; (c) more than eight or less than eight memory packages 502; and/or (d) more than sixteen or less than sixteen memory dies 520 per memory package 502. Additionally, or alternatively, the memory device 500 can include a greater or lesser number of external pins (e.g., more than four or less than four external pins) per memory package 502, and/or a greater or lesser number (e.g., more than four or less than four) memory dies 520 per group. In some embodiments, the number of memory dies 520, external pins, and/or back-end channels 518 coupled to a memory package 502, can vary across memory packages 502 of the memory device 500. The number of memory dies 520 per group may vary across groups within a memory package 502 and/or across memory packages 502. Furthermore, although shown with a single switch matrix 504 in FIG. 5, the memory device 500 may include more than one switch matrix 504 in other embodiments. Moreover, all or a subset of the switch matrix 504 can be incorporated into the controller 506 and/or into one or more of the memory packages 502 in some embodiments.

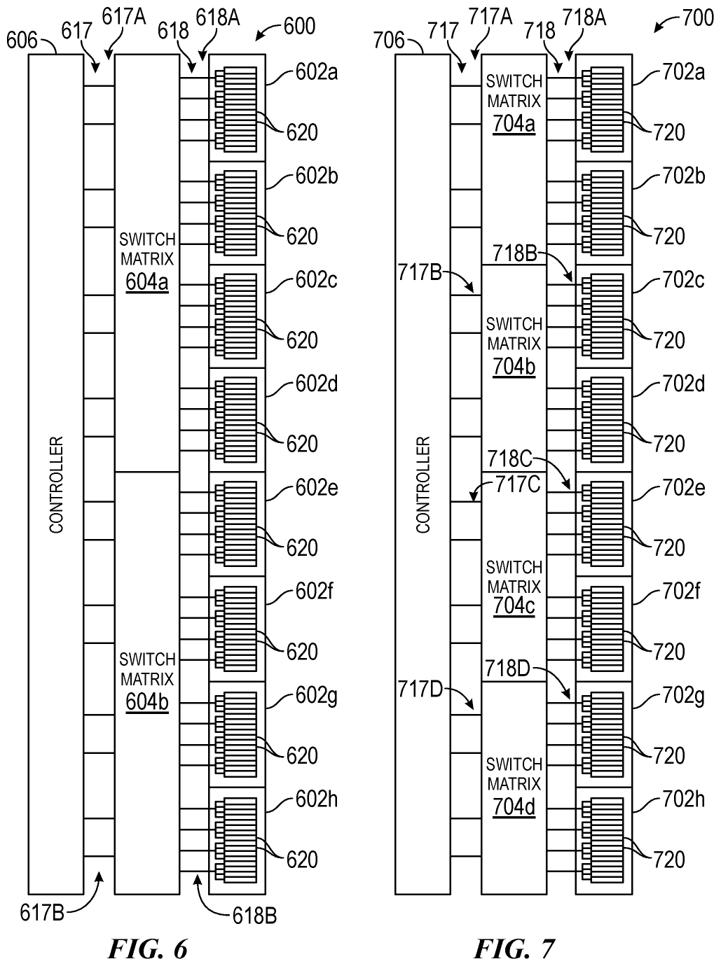

Referring to FIG. 6, the memory device 600 is similar to the memory device 500 of FIG. 5 in that the memory device 600 includes a controller 606 and a plurality of memory packages 602 (identified individually in FIG. 6 as memory packages 602a-602h). In addition, each memory package 602 includes sixteen memory dies 620 that are organized into groups of four, with each group operably coupled to (a) an external pin or terminal of the corresponding memory package 602 and/or (b) a corresponding back-end channel 618. Thus, four back-end channels 618 are coupled to each of the memory packages 602. The memory device 600 further includes sixteen front-end channels 617.

In contrast with the memory device 500, the memory device 600 includes two switch matrices 604 (identified individually in FIG. 6 as first switch matrix 604a and second switch matrix 604b) that are positioned between the controller 606 and the plurality of memory packages 602, such as on a PCB or other substrate on which the controller 606 and/or the memory packages 602 may also be positioned. Each of the switch matrices 604 operably couples the controller 606 to a corresponding subset of the memory packages 602. More specifically, the first switch matrix 604a operably couples the controller 606 to the memory packages 602a-602d via a first set 617A of eight front-end channels 617 and a first set 618A of sixteen back-end channels 618, and the second switch matrix 604b operably couples the controller 606 to the memory packages 602e-602h via a second set 617B of eight front-end channels 617 and a second set 618B of sixteen back-end channels 618. Therefore, the switch matrices 604 can each be referred to as an 8:16 switch matrix.

In operation, the first switch matrix 604a can be configured to selectively couple any one or more of the front-end channels 617 in the first set 617A to any one or more of the back-end channels 618 in the first set 618A, and/or to selectively couple any two or more of the back-end channels 618 in the first set 618A to one another. Additionally, or alternatively, the second switch matrix 604b can be configured to selectively couple any one or more of the front-end channels 617 in the second set 617B to any one or more of the back-end channels 618 in the second set 618B, and/or to selectively couple any two or more of the back-end channels 618 in the second set 618B to one another.

Because each of the back-end channels 618 is operably coupled to an individual group of four memory dies 620 in the illustrated embodiment, the switch matrices 604 can facilitate the controller 606 communicating directly with individual groups of memory dies 620 of a memory package 602. In contrast to the memory device 500 of FIG. 5, use of two separate switch matrices 604 facilitates (a) use of only the first set 617A of front-end channels 617 to communicate with the memory dies 620 of the memory packages 602a-602d, and/or (b) use of only the second set 617B of front-end channels 617 to communicate with the memory dies 620 of the memory packages 602e-602h. Stated another way, the first set 617A of front-end channels 617 cannot be used to communicate with the memory dies 620 of the memory packages 602e-602h, and/or the second set 617B of front-end channels 617 cannot be used to communicate with the memory dies 620 of the memory packages 602a-602d. Thus, the switch matrices 604 can provide less switching flexibility across the front-end channels 617 than the switch matrix 504 of FIG. 5, but can offer a reduction in routing complexity (e.g., less switching circuitry internal each of the switch matrices 604) and/or an increase in positioning flexibility (e.g., a greater number of possible locations on the PCB or other substrate at which the switch matrices 604 can be placed) in comparison to the memory device 500.

Although shown with sixteen front-end channels 617, thirty-two (32) back-end channels 618, eight memory packages 602, and sixteen memory dies 620 per memory package 602, the memory device 500 can, in other embodiments, include (a) more than sixteen or less than sixteen front-end channels 617; (b) more than thirty-two (32) or less than thirty-two (32) back-end channels 618; (c) more than eight or less than eight memory packages 602; and/or (d) more than sixteen or less than sixteen memory dies 620 per memory package 602. In addition, although each of the switch matrices 604 is illustrated as being coupled to eight front-end channels 617 and sixteen back-end channels 618, more than eight or less than eight front-end channels 617 can be coupled to a switch matrix 604 and/or more than sixteen or less than sixteen back-end channels 618 can be coupled to a switch matrix 604, in other embodiments. The number of front-end channels 617 and/or back-end channels 618 coupled to a switch matrix 604 can vary across switch matrices 604 of the memory device 600.

Additionally, or alternatively, the memory device 600 can include a greater or lesser number of external pins (e.g., more than four or less than four external pins) per memory package 602, and/or a greater or lesser number of memory dies 620 per group (e.g., more than four or less than four memory dies 620 per group). The number of memory dies 620, external pins, and/or back-end channels 618 coupled to a memory package 602, can vary across memory packages 602 of a memory device 600 in some embodiments. The number of memory dies 620 per group may vary across groups within a memory package 602 and/or across memory packages 602. Furthermore, although shown with two switch matrices 604 in FIG. 6, the memory device 600 may include more than two or less than two switch matrices 604 in other embodiments. Moreover, all or a subset of one or more of the switch matrices 604 can be incorporated into the controller 606 and/or into one or more of the memory packages 602 in some embodiments.

Referring to FIG. 7, the memory device 700 is similar to the memory device 600 of FIG. 6 in that the memory device 700 includes a controller 706 and a plurality of memory packages 702 (identified individually in FIG. 7 as memory packages 702a-702h). In addition, each memory package 702 includes sixteen memory dies 720 that are organized into groups of four, with each group operably coupled to (a) an external pin or terminal of the corresponding memory package 702 and/or (b) a corresponding back-end channel 718. Thus, four back-end channels 718 are coupled to each of the memory packages 702. The memory device 700 further includes sixteen front-end channels 717.

In contrast with the memory device 600, the memory device 700 includes four switch matrices 704 (identified individually in FIG. 7 as switch matrices 704a-704d) that are positioned between the controller 706 and the plurality of memory packages 702, such as on a PCB or other substrate on which the controller 706 and/or the memory packages 702 may also be positioned. Each of the switch matrices 704 operably couples the controller 706 to a corresponding subset of the memory packages 702. More specifically, a first switch matrix 704a operably couples the controller 706 to the memory packages 702a and 702b via a first set 717A of four front-end channels 717 and a first set 718A of eight back-end channels 718; a second switch matrix 704b operably couples the controller 706 to the memory packages 702c and 702d via a second set 717B of four front-end channels 717 and a second set 718B of eight back-end channels 718; a third switch matrix 704c operably couples the controller 706 to the memory packages 702e and 702f via a third set 717C of four front-end channels 717 and a third set 718C of eight back-end channels 718; and a fourth switch matrix 704d operably couples the controller 706 to the memory packages 702g and 702h via a fourth set 717D of four front-end channels 717 and a fourth set 718D of eight back-end channels 718. Therefore, the switch matrices 604 can each be referred to as a 4:8 switch matrix.

In operation, the first switch matrix 704a can be configured to selectively couple any one or more of the front-end channels 717 in the first set 717A to any one or more of the back-end channels 718 in the first set 718A, and/or to selectively couple any two or more of the back-end channels 718 in the first set 718A to one another. Additionally, or alternatively, the second switch matrix 704b can be configured to selectively couple any one or more of the front-end channels 717 in the second set 717B to any one or more of the back-end channels 718 in the second set 718B, and/or to selectively couple any two or more of the back-end channels 718 in the second set 718B to one another. In these and other embodiments, the third switch matrix 704c can be configured to selectively couple any one or more of the front-end channels 717 in the third set 717C to any one or more of the back-end channels 718 in the third set 718C, and/or to selectively couple any two or more of the back-end channels 718 in the third set 718C to one another. In these and still other embodiments, the fourth switch matrix 704d can be configured to selectively couple any one or more of the front-end channels 717 in the fourth set 717D to any one or more of the back-end channels 718 in the fourth set 718D, and/or to selectively couple any two or more of the back-end channels 718 in the fourth set 718D to one another.

Because each of the back-end channels 718 is operably coupled to an individual group of four memory dies 720 in the illustrated embodiment, the switch matrices 704 can facilitate the controller 706 communicating directly with individual groups of memory dies 720 of a memory package 702. In contrast to the memory device 600 of FIG. 6, use of four separate switch matrices 704 facilitates use of only the first set 717A of front-end channels 717 to communicate with the memory dies 720 of the memory packages 702a and 702b, use of only the second set 717B of front-end channels 717 to communicate with the memory dies 720 of the memory packages 702c and 702d, use of only the third set 717C of front-end channels 717 to communicate with the memory dies 720 of the memory packages 702e and 702f, and/or use of only the fourth set 717D of front-end channels 717 to communicate with the memory dies 720 of the memory packages 702g and 702h. Thus, the switch matrices 704 can provide less switching flexibility across the front-end channels 717 than the switch matrices 604 of FIG. 6, but can offer a reduction in routing complexity (e.g., less switching circuitry internal each of the switch matrices 704) and/or an increase in positioning flexibility (e.g., a greater number of possible locations on the PCB or other substrate at which the switch matrices 704 can be placed) in comparison to the memory device 600.

Although shown with sixteen front-end channels 717, thirty-two (32) back-end channels 718, eight memory packages 702, and sixteen memory dies 720 per memory package 702, the memory device 700 can, in other embodiments, include (a) more than sixteen or less than sixteen front-end channels 717; (b) more than thirty-two (32) or less than thirty-two (32) back-end channels 718; (c) more than eight or less than eight memory packages 702; and/or (d) more than sixteen or less than sixteen memory dies 720 per memory package 702. In addition, although each of the switch matrices 704 is illustrated as being coupled to four front-end channels 717 and eight back-end channels 718, more than four or less than four front-end channels 717 can be coupled to a switch matrix 704 and/or more than eight or less than eight back-end channels 718 can be coupled to a switch matrix 704, in other embodiments. The number of front-end channels 717 and/or back-end channels 718 coupled to a switch matrix 704 can vary across switch matrices 704 of the memory device 700.

Additionally, or alternatively, the memory device 700 can include a greater or lesser number of external pins (e.g., more than four or less than four external pins) per memory package 702, and/or a greater or lesser number of memory dies 720 per group (e.g., more than four or less than four memory dies 720 per group). The number of memory dies 720, external pins, and/or back-end channels 718 coupled to a memory package 702, can vary across memory packages 702 of a memory device 700 in some embodiments. The number of memory dies 720 per group may vary across groups within a memory package 702 and/or across memory packages 702. Furthermore, although shown with four switch matrices 704 in FIG. 7, the memory device 700 may include more than four or less than four switch matrices 704 in other embodiments. Moreover, all or a subset of one or more of the switch matrices 704 can be incorporated into the controller 706 and/or into one or more of the memory packages 702 in some embodiments.

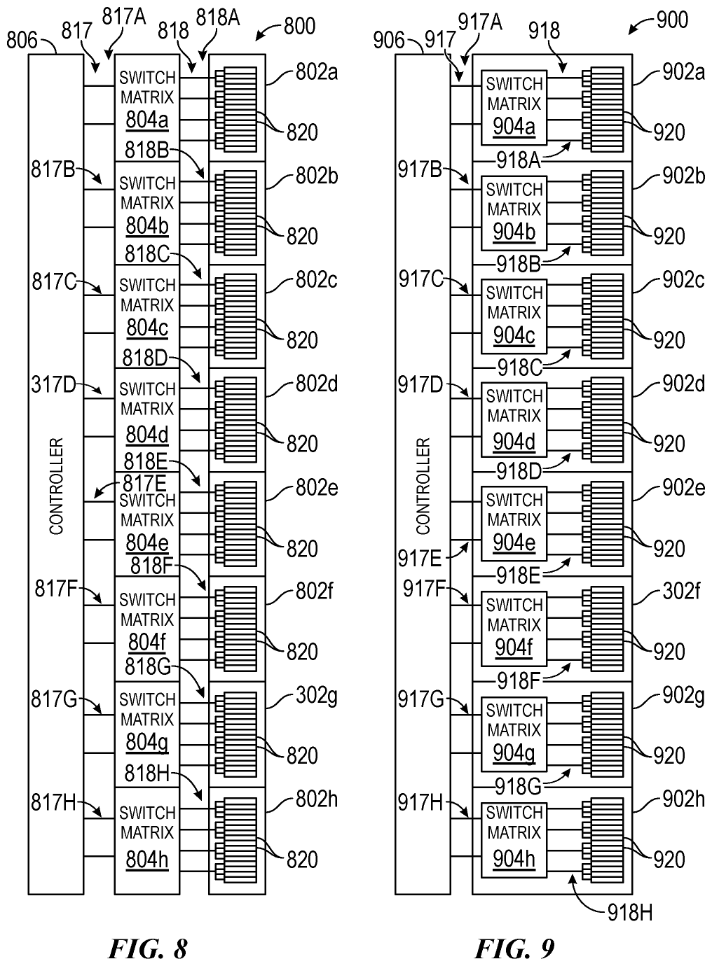

Referring to FIG. 8, the memory device 800 is similar to the memory device 700 of FIG. 7 in that the memory device 800 includes a controller 806 and a plurality of memory packages 802 (identified individually in FIG. 8 as memory packages 802a-802h). In addition, each memory package 802 includes sixteen memory dies 820 that are organized into groups of four, with each group operably coupled to (a) an external pin or terminal of the corresponding memory package 802 and/or (b) a corresponding back-end channel 818. Thus, four back-end channels 818 are coupled to each of the memory packages 802. The memory device 800 further includes sixteen front-end channels 817.

In contrast with the memory device 700, the memory device 800 includes eight switch matrices 804 (identified individually in FIG. 8 as switch matrices 804a-804d) that are positioned between the controller 806 and the plurality of memory packages 802, such as on a PCB or other substrate on which the controller 806 and/or the memory packages 802 may also be positioned. Each of the switch matrices 804 operably couples the controller 806 to a corresponding one of the memory packages 802. More specifically, a first switch matrix 804a operably couples the controller 806 to the memory package 802a via a first set 817A of two front-end channels 817 and a first set 818A of four back-end channels 818; a second switch matrix 804b operably couples the controller 806 to the memory package 802b via a second set 817B of two front-end channels 817 and a second set 818B of four back-end channels 818; a third switch matrix 804c operably couples the controller 806 to the memory package 802c via a third set 817C of two front-end channels 817 and a third set 818C of four back-end channels 818; a fourth switch matrix 804d operably couples the controller 806 to the memory package 802d via a fourth set 817D of two front-end channels 817 and a fourth set 818D of four back-end channels 818; a fifth switch matrix 804e operably couples the controller 806 to the memory package 802e via a fifth set 817E of two front-end channels 817 and a fifth set 818E of four back-end channels 818; a sixth switch matrix 804f operably couples the controller 806 to the memory package 802f via a sixth set 817F of two front-end channels 817 and a sixth set 818F of four back-end channels 818; a seventh switch matrix 804g operably couples the controller 806 to the memory package 802g via a seventh set 817G of two front-end channels 817 and a seventh set 818G of four back-end channels 818; and an eighth switch matrix 804h operably couples the controller 806 to the memory package 802h via an eighth set 817H of two front-end channels 817 and an eighth set 818H of four back-end channels 818. Therefore, the switch matrices 804 can each be referred to as a 2:4 switch matrix.

In operation, the first switch matrix 804a can be configured to selectively couple any one or more of the front-end channels 817 in the first set 817A to any one or more of the back-end channels 818 in the first set 818A, and/or to selectively couple any two or more of the back-end channels 818 in the first set 818A to one another. Additionally, or alternatively, the second switch matrix 804b can be configured to selectively couple any one or more of the front-end channels 817 in the second set 817B to any one or more of the back-end channels 818 in the second set 818B, and/or to selectively couple any two or more of the back-end channels 818 in the second set 818B to one another. In these and other embodiments, the third switch matrix 804c can be configured to selectively couple any one or more of the front-end channels 817 in the third set 817C to any one or more of the back-end channels 818 in the third set 818C, and/or to selectively couple any two or more of the back-end channels 818 in the third set 818C to one another. In these and still other embodiments, the fourth switch matrix 804d can be configured to selectively couple any one or more of the front-end channels 817 in the fourth set 817D to any one or more of the back-end channels 818 in the fourth set 818D, and/or to selectively couple any two or more of the back-end channels 818 in the fourth set 818D to one another.

In these and other embodiments, the fifth switch matrix 804e can be configured to selectively couple any one or more of the front-end channels 817 in the fifth set 817E to any one or more of the back-end channels 818 in the fifth set 818E, and/or to selectively couple any two or more of the back-end channels 818 in the fifth set 818E to one another. Additionally, or alternatively, the sixth switch matrix 804f can be configured to selectively couple any one or more of the front-end channels 817 in the sixth set 817F to any one or more of the back-end channels 818 in the sixth set 818F, and/or to selectively couple any two or more of the back-end channels 818 in the sixth set 818F to one another. In these and other embodiments, the seventh switch matrix 804g can be configured to selectively couple any one or more of the front-end channels 817 in the seventh set 817G to any one or more of the back-end channels 818 in the seventh set 818G, and/or to selectively couple any two or more of the back-end channels 818 in the seventh set 818G to one another. In these and still other embodiments, the eighth switch matrix 804h can be configured to selectively couple any one or more of the front-end channels 817 in the eighth set 817H to any one or more of the back-end channels 818 in the eighth set 818H, and/or to selectively couple any two or more of the back-end channels 818 in the eighth set 818H to one another.

Because each of the back-end channels 818 is operably coupled to an individual group of four memory dies 820 in the illustrated embodiment, the switch matrices 804 can facilitate the controller 806 communicating directly with individual groups of memory dies 820 of a memory package 802. In contrast to the memory device 700 of FIG. 7, use of eight separate switch matrices 804 facilitates use of only the first set 817A of front-end channels 817 to communicate with the memory dies 820 of the memory package 802a, use of only the second set 817B of front-end channels 817 to communicate with the memory dies 820 of the memory package 802b, use of only the third set 817C of front-end channels 817 to communicate with the memory dies 820 of the memory package 802c, use of only the fourth set 817D of front-end channels 817 to communicate with the memory dies 820 of the memory package 802d, use of only the fifth set 817E of front-end channels 817 to communicate with the memory dies 820 of the memory package 802e, use of only the sixth set 817F of front-end channels 817 to communicate with the memory dies 820 of the memory package 802f, use of only the seventh set 817G of front-end channels 817 to communicate with the memory dies 820 of the memory package 802g, and/or use of only the eighth set 817H of front-end channels 817 to communicate with the memory dies 820 of the memory package 802h. Thus, the switch matrices 804 can provide less switching flexibility across the front-end channels 817 than the switch matrices 704 of FIG. 7, but can offer a reduction in routing complexity (e.g., less switching circuitry internal each of the switch matrices 804) and/or an increase in positioning flexibility (e.g., a greater number of possible locations on the PCB or other substrate at which the switch matrices 804 can be placed) in comparison to the memory device 700.

Although shown with sixteen front-end channels 817, thirty-two (32) back-end channels 818, eight memory packages 802, and sixteen memory dies 820 per memory package 802, the memory device 800 can, in other embodiments, include (a) more than sixteen or less than sixteen front-end channels 817; (b) more than thirty-two (32) or less than thirty-two (32) back-end channels 818; (c) more than eight or less than eight memory packages 802; and/or (d) more than sixteen or less than sixteen memory dies 820 per memory package 802. In addition, although each of the switch matrices 804 is illustrated as being coupled to two front-end channels 817 and four back-end channels 818, more than two or less than two front-end channels 817 can be coupled to a switch matrix 804 and/or more than four or less than four back-end channels 818 can be coupled to a switch matrix 804, in other embodiments. The number of front-end channels 817 and/or back-end channels 818 coupled to a switch matrix 804 can vary across switch matrices 804 of the memory device 800.

Additionally, or alternatively, the memory device 800 can include a greater or lesser number of external pins (e.g., more than four or less than four external pins) per memory package 802, and/or a greater or lesser number of memory dies 820 per group (e.g., more than four or less than four memory dies 820 per group). The number of memory dies 820, external pins, and/or back-end channels 818 coupled to a memory package 802, can vary across memory packages 802 of a memory device 800 in some embodiments. The number of memory dies 820 per group may vary across groups within a memory package 802 and/or across memory packages 802. Furthermore, although shown with eight switch matrices 804 in FIG. 8, the memory device 800 may include more than eight or less than eight switch matrices 804 in other embodiments. Moreover, all or a subset of one or more of the switch matrices 804 can be incorporated into the controller 806 and/or into one or more of the memory packages 802 in some embodiments.

Referring to FIG. 9, the memory device 900 is similar to the memory device 800 of FIG. 8 in that the memory device 900 includes a controller 906 and a plurality of memory packages 902 (identified individually in FIG. 9 as memory packages 902a-902h). In addition, each memory package 902 includes sixteen memory dies 920 that are organized into groups of four. The memory device 800 further includes (a) sixteen front-end channels 917 and (b) eight switch matrices 904 (identified individually in FIG. 9 as switch matrices 904a-904h) that are each a 2:4 switch matrix.

In contrast with the memory device 800, the memory device 900 incorporates the switch matrices 904 (identified individually in FIG. 8 as switch matrices 904a-904h) into corresponding memory packages 902. For example, a first switch matrix 904a is incorporated into the first memory package 902a, a second switch matrix 904b is incorporated into the second memory package 902b, a third switch matrix 904c is incorporated into the third memory package 902c, a fourth switch matrix 904d is incorporated into the fourth memory package 902d, a fifth switch matrix 904e is incorporated into the fifth memory package 902e, a sixth switch matrix 904f is incorporated into the sixth memory package 902f, a seventh switch matrix 904g is incorporated into the seventh memory package 902g, and/or an eighth switch matrix 904h is incorporated into the eighth memory package 902h. In some embodiments, a switch matrix 904 can be positioned on or in a package substrate of a corresponding memory package 902. In these and other embodiments, all or a subset of a switch matrix 904 can be incorporated into circuitry (e.g., an input/output expander) internal the corresponding memory package 902, can be separate from such circuitry, and/or can be standalone circuitry within the corresponding memory package 902.

As shown in FIG. 9, each of the switch matrices 904 is operably coupled to a corresponding set (e.g., to one of the sets 917A-917H) of front-end channels 917 (e.g., via one or more external pins or terminals of the corresponding memory package 902). In addition, each of the switch matrices 904 is operably coupled to four groups of memory dies 920 in a corresponding memory package 902 via a corresponding set (e.g., one of the sets 918A-918H) of back-end channels 918 positioned internal the corresponding memory package 902 (e.g., as opposed to via a corresponding set of back-end channels positioned external the corresponding memory package, as is shown in FIGS. 4-8). For example, the first switch matrix 904a is operably coupled (a) to the controller 906 via a first set 917A of two front-end channels 917 and (b) to four groups of memory dies 920 via a first set 918A of four back-end channels 918 that are internal a first memory package 902a.

In operation, the first switch matrix 904a can be configured to selectively couple any one or more of front-end channels 917 of the first set 917A to any one or more of the back-end channels 918 in the first set 918A, and/or to selectively couple any two or more of the back-end channels 918 in the first set 918A to one another. Additionally, or alternatively, the second switch matrix 904b can be configured to selectively couple any one or more of the front-end channels 917 in a second set 917B to any one or more of the back-end channels 918 in a second set 918B, and/or to selectively couple any two or more of the back-end channels 918 in the second set 918B to one another. In these and other embodiments, the third switch matrix 904c can be configured to selectively couple any one or more of the front-end channels 917 in a third set 917C to any one or more of the back-end channels 918 in a third set 918C, and/or to selectively couple any two or more of the back-end channels 918 in the third set 918C to one another. In these and still other embodiments, the fourth switch matrix 904d can be configured to selectively couple any one or more of the front-end channels 917 in a fourth set 917D to any one or more of the back-end channels 918 in a fourth set 918D, and/or to selectively couple any two or more of the back-end channels 918 in the fourth set 918D to one another.

In these and other embodiments, the fifth switch matrix 904e can be configured to selectively couple any one or more of the front-end channels 917 in a fifth set 917E to any one or more of the back-end channels 918 in a fifth set 918E, and/or to selectively couple any two or more of the back-end channels 918 in the fifth set 918E to one another. Additionally, or alternatively, the sixth switch matrix 904f can be configured to selectively couple any one or more of the front-end channels 917 in a sixth set 917F to any one or more of the back-end channels 918 in a sixth set 918F, and/or to selectively couple any two or more of the back-end channels 918 in the sixth set 918F to one another. In these and other embodiments, the seventh switch matrix 904g can be configured to selectively couple any one or more of the front-end channels 917 in a seventh set 917G to any one or more of the back-end channels 918 in a seventh set 918G, and/or to selectively couple any two or more of the back-end channels 918 in the seventh set 918G to one another. In these and still other embodiments, the eighth switch matrix 904h can be configured to selectively couple any one or more of the front-end channels 917 in an eighth set 917H to any one or more of the back-end channels 918 in an eighth set 918H, and/or to selectively couple any two or more of the back-end channels 918 in the eighth set 918H to one another.

Because each of the back-end channels 918 is operably coupled to an individual group of four memory dies 920 in the illustrated embodiment, the switch matrices 904 can facilitate the controller 906 communicating directly with individual groups of memory dies 920 of a memory package 902. Similar to the memory device 800 of FIG. 8, use of eight separate switch matrices 904 facilitates use of only the first set 917A of front-end channels 917 to communicate with the memory dies 920 of the memory package 902a, use of only the second set 917B of front-end channels 917 to communicate with the memory dies 920 of the memory package 902b, use of only the third set 917C of front-end channels 917 to communicate with the memory dies 920 of the memory package 902c, use of only the fourth set 917D of front-end channels 917 to communicate with the memory dies 920 of the memory package 902d, use of only the fifth set 917E of front-end channels 917 to communicate with the memory dies 920 of the memory package 902e, use of only the sixth set 917F of front-end channels 917 to communicate with the memory dies 920 of the memory package 902f, use of only the seventh set 917G of front-end channels 917 to communicate with the memory dies 920 of the memory package 902g, and/or use of only the eighth set 917H of front-end channels 917 to communicate with the memory dies 920 of the memory package 902h. Thus, the switch matrices 904 can provide similar switching flexibility across the front-end channels 917 as the switch matrices 804 of FIG. 8, and can offer a reduction in routing complexity (e.g., less external pins on each memory package 902) and/or a reduction in space occupied by the switch matrices 904 (e.g., on the PCB and/or in general, such as when incorporated into an input/output expander or other circuitry of the corresponding memory package 902), in comparison to the memory device 800.

Although shown with sixteen front-end channels 917, thirty-two (32) internal back-end channels 918, eight memory packages 902, and sixteen memory dies 920 per memory package 902, the memory device 900 can, in other embodiments, include (a) more than sixteen or less than sixteen front-end channels 917; (b) more than thirty-two (32) or less than thirty-two (32) internal back-end channels 918; (c) more than eight or less than eight memory packages 902; and/or (d) more than sixteen or less than sixteen memory dies 920 per memory package 902. In addition, although each of the switch matrices 904 is illustrated as being coupled to two front-end channels 917 and four internal back-end channels 918, more than two or less than two front-end channels 917 can be coupled to a switch matrix 904 and/or more than four or less than four internal back-end channels 918 can be coupled to a switch matrix 904, in other embodiments. The number of front-end channels 917 and/or internal back-end channels 918 coupled to a switch matrix 904 can vary across switch matrices 904 of the memory device 900.

Additionally, or alternatively, the memory device 900 can include a greater or lesser number of external pins (e.g., more than two or less than two external pins) per memory package 902, and/or a greater or lesser number of memory dies 920 per group (e.g., more than four or less than four memory dies 920 per group). The number of memory dies 920, external pins, and/or internal back-end channels 918 coupled to a memory package 902, can vary across memory packages 902 of a memory device 900 in some embodiments. The number of memory dies 920 per group may vary across groups within a memory package 902 and/or across memory packages 902. Furthermore, although shown with eight switch matrices 904 in FIG. 9, the memory device 900 may include more than eight or less than eight switch matrices 904 in other embodiments. Moreover, all or a subset of one or more of the switch matrices 904 can be incorporated into the controller 906 and/or positioned external one or more of the memory packages 902 in some embodiments.

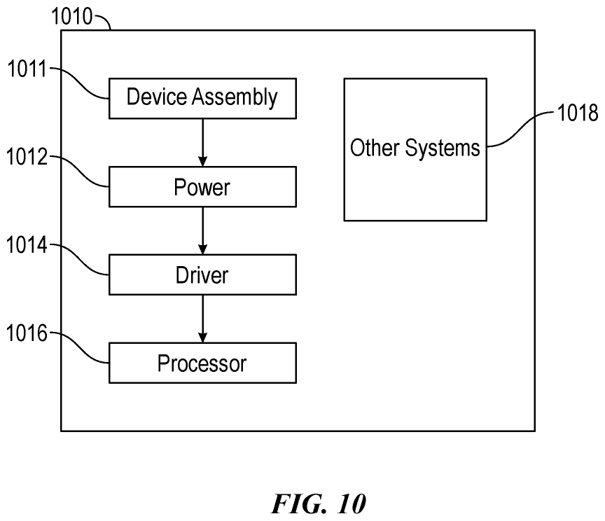

FIG. 10 is a schematic view of a system that includes a memory device in accordance with various embodiments of the present technology. Any one of the foregoing memory devices described above with reference to FIGS. 2-9 can be incorporated into any of a myriad of larger and/or more complex systems, a representative example of which is system 1010 shown schematically in FIG. 10. The system 1010 can include a semiconductor device assembly 1011, a power source 1012, a driver 1014, a processor 1016, and/or other subsystems and components 1018. The semiconductor device assembly 1011 can include features generally similar to those of the memory devices described above with reference to FIGS. 2-9, and can, therefore, include memory devices with switchable channels. The resulting system 1010 can perform any of a wide variety of functions, such as memory storage, data processing, and/or other suitable functions. Accordingly, representative systems 1010 can include, without limitation, hand-held devices (e.g., mobile phones, tablets, digital readers, and digital audio players), computers, vehicles, appliances, and other products. Components of the system 1010 may be housed in a single unit or distributed over multiple, interconnected units (e.g., through a communications network). The components of the system 1010 can also include remote devices and any of a wide variety of computer-readable media.

### C. CONCLUSION

As used herein, the terms “memory system” and “memory device” refer to systems and devices configured to temporarily and/or permanently store information related to various electronic devices. Accordingly, the term “memory device” can refer to a single memory die, to a memory package containing one or more memory dies, to a memory package operably coupled to a memory controller, and/or to a plurality of memory packages operably coupled to a memory controller. Similarly, the term “memory system” can refer to a system including one or more memory dies (e.g., a memory package); to a memory package operably coupled to a memory controller; to a plurality of memory packages operably coupled to a memory controller (e.g., to a dual in-line memory module (DIMM), such as a non-volatile DIMM (NVDIMM)); and/or to a system including one or more memory packages, a memory controller, and/or a host device.

From the foregoing, it will be appreciated that specific embodiments of the technology have been described herein for purposes of illustration, but well-known structures and functions have not been shown or described in detail to avoid unnecessarily obscuring the description of the embodiments of the technology. Where the context permits, singular or plural terms can also include the plural or singular term, respectively. Moreover, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. As used herein, the phrase “and/or” as in “A and/or B” refers to A alone, B alone, and both A and B. Additionally, the terms “comprising,” “including,” “having,” and “with” are used throughout to mean including at least the recited feature(s) such that any greater number of the same feature(s) and/or additional types of other features are not precluded. Moreover, the terms “connect” and “couple” are used interchangeably herein and refer to both direct and indirect connections or couplings. For example, where the context permits, element A “connected” or “coupled” to element B can refer (i) to A directly “connected” or directly “coupled” to B and/or (ii) to A indirectly “connected” or indirectly “coupled” to B.

The above detailed descriptions of embodiments of the technology are not intended to be exhaustive or to limit the technology to the precise form disclosed above. Although specific embodiments of, and examples for, the technology are described above for illustrative purposes, various equivalent modifications are possible within the scope of the technology, as those skilled in the relevant art will recognize. For example, while steps are presented in a given order, alternative embodiments can perform steps in a different order. As another example, various components of the technology can be further divided into subcomponents, and/or various components and/or functions of the technology can be combined and/or integrated. Furthermore, although advantages associated with certain embodiments of the technology have been described in the context of those embodiments, other embodiments can also exhibit such advantages, and not all embodiments need necessarily exhibit such advantages to fall within the scope of the present technology.

It should also be noted that other embodiments in addition to those disclosed herein are within the scope of the present technology. For example, embodiments of the present technology can have different configurations, components, and/or procedures in addition to those shown or described herein. Moreover, a person of ordinary skill in the art will understand that these and other embodiments can be without several of the configurations, components, and/or procedures shown or described herein without deviating from the present technology. Accordingly, the disclosure and associated technology can encompass other embodiments not expressly shown or described herein.

What is claimed is:

1. A system, comprising:
a controller;
a plurality of memory dies; and
a switch matrix (a) coupled to the controller via two or more controller-side channels and (b) coupled to the plurality of memory dies via a set of memory-side channels,
wherein the switch matrix is configured to selectively couple each controller-side channel of the two or more controller-side channels to each memory-side channel of the set of memory-side channels to provide dynamically configurable connections between the controller and one or more memory dies of the plurality of memory dies.

2. The system of claim 1, wherein the plurality of memory dies is arranged in one or more memory packages, and wherein the switch matrix is positioned external the controller and the one or more memory packages.

3. The system of claim 1, wherein the plurality of memory dies is arranged in a memory package, and wherein the switch matrix is positioned internal the memory package.

4. The system of claim 3, wherein at least a portion of the switch matrix is included within an input/output expander of the memory package.

5. The system of claim 1, wherein each memory-side channel of the set of memory-side channels is coupled to a unique memory die in the plurality of memory dies.

6. The system of claim 1, wherein the plurality of memory dies includes multiple groupings each having two or more memory dies, and wherein each memory-side channel of the set of memory-side channels is coupled to a unique grouping of the multiple groupings.

7. The system of claim 1, wherein the plurality of memory dies is arranged in two or more memory packages, and wherein the switch matrix is coupled to each memory package of the two or more memory packages via a unique subset of memory-side channels of the set of memory-side channels.

8. The system of claim 1, wherein:
the switch matrix is a first switch matrix, the two or more controller-side channels is a first plurality of controller-side channels, the set of memory-side channels is a first set of memory-side channels, and the plurality of memory dies is a first plurality of memory dies;
the system further comprises a second switch matrix (a) coupled to the controller via a second plurality of controller-side channels different from the first plurality of controller-side channels and (b) coupled to a second plurality of memory dies via a second set of memory-side channels different from the first set of memory-side channels; and
the second plurality of memory dies is different from the first plurality of memory dies.

9. The system of claim 8, wherein the second switch matrix is configured to selectively couple each controller-side channel of the second plurality of controller-side channels to each memory-side channel of the second set of memory-side channels to provide dynamically configurable connections between the controller and one or more memory dies of the second plurality of memory dies.

10. The system of claim 1, wherein the controller is configured to communicate with the switch matrix and/or the plurality of memory dies according to Open NAND Flash Interface (ONFI) communication protocols.

11. The system of claim 1, wherein the controller includes a command queue that is shared amongst all controller-side channels of the two or more controller-side channels.

12. The system of claim 1, wherein the system is a solid-state drive and/or each memory die of the plurality of memory dies includes a plurality of non-volatile memory cells.

13. A system, comprising:
a controller;
a plurality of memory dies including a first set of memory dies and a second set of memory dies different from the first set;
a first switch matrix (a) coupled to the controller via a first plurality of controller-side channels and (b) coupled to the first set of memory dies via a first plurality of memory-side channels, wherein the first switch matrix is configured to selectively couple each controller-side channel of the first plurality of controller-side channels to each memory-side channel of the first plurality of memory-side channels to provide dynamically configurable connections between the controller and one or more memory dies of the first set of memory dies; and
a second switch matrix (a) coupled to the controller via a second plurality of controller-side channels and (b) coupled to the second set of memory dies via a second plurality of memory-side channels, wherein the second switch matrix is configured to selectively couple each controller-side channel of the second plurality of controller-side channels to each memory-side channel of the second plurality of memory-side channels to provide dynamically configurable connections between the controller and one or more memory dies of the second set of memory dies.

14. The system of claim 13, wherein the plurality of memory dies is arranged in one or more memory packages, and wherein the first switch matrix and/or the second switch matrix is positioned external the controller and the one or more memory packages.

15. The system of claim 13, wherein the plurality of memory dies is arranged in one or more memory packages, and wherein the first switch matrix and/or the second switch matrix is positioned internal a memory package of the one or more memory packages.

16. The system of claim 15, wherein at least a portion of the first switch matrix and/or at least a portion of the second switch matrix is included within an input/output expander of the memory package.

17. The system of claim 13, wherein:
the plurality of memory dies includes a third set of memory dies different from the first and second sets of memory dies;
the system further comprises a third switch matrix (a) coupled to the controller via a third plurality of controller-side channels and (b) coupled to the third set of memory dies via a third plurality of memory-side channels; and
the third switch matrix is configured to selectively couple each controller-side channel of the third plurality of controller-side channels to each memory-side channel of the third plurality of memory-side channels to provide dynamically configurable connections between the controller and one or more memory dies of the third set of memory dies.

18. The system of claim 13, wherein the first set of memory dies is arranged in a memory package, and wherein the first plurality of memory-side channels are dedicated to the memory package.

19. The system of claim 13, wherein the first set of memory dies is arranged in two or more memory packages, and wherein two memory-side channels of the first plurality of memory-side channels are dedicated to different memory packages of the two or more memory packages from one another.

20. An enterprise memory system, comprising:
a controller couplable to a host device;
one or more memory devices; and
a switch matrix coupling the controller to the one or more memory devices, wherein the switch matrix (a) is coupled to the controller via multiple controller-side channels and (b) is coupled to the one or more memory devices via one or more memory-side channels, and wherein the switch matrix is configured to selectively couple each controller-side channel of the multiple controller-side channels to each memory-side channel of the one or more memory side channels.
